(19) United States
(12) Patent Application Publication
(10) Pub. No.: US 2026/0286036 A1
(43) Pub. Date: Sep. 24, 2026

(54) LOW RESIDUAL MOMOMER GLYCOL AROMATIC POLYESTER POLYOLS

(71) Applicant: Stepan Company, Northbrook, IL (US)

(72) Inventors: Carina ARAULLO-MCADAMS, Leland, NC (US); Carson CLINE, Wilmington, NC (US); Lei CUI, Bolingbrook, IL (US)

(21) Appl. No.: 19/474,195

(22) PCT Filed: Apr. 12, 2024
(86) PCT No.: PCT/US2024/024274

§ 371 Date: Oct. 10, 2025

Related U.S. Application Data
(60) Provisional application No. 63/458,922, filed on Apr. 12, 2023.

(51) Int. Cl. C08G 18/42; C08G 18/46; C08G 63/672; C08G 63/685

(52) U.S. Cl. CPC C08G 18/4252; C08G 18/4623; C08G 63/672; C08G 63/6856; C08G 2110/0083

(57) ABSTRACT

An aromatic polyester polyol comprising:
a total product OH value of 150 to 450;
a viscosity of less than 12,000 cps;
an OH value from residual monomer glycols of <30% of the total product OH value;
residual monomer glycols in an amount of less than 10 wt %; and
a level of 1,4 dioxanes less than 50.

### FIELD OF THE INVENTION

The invention relates to low residual monomer glycol aromatic polyester polyols. More particularly, the invention relates to low residual monomer glycol aromatic polyester polyols produced using a thermal separation process under vacuum.

### BACKGROUND

Energy usage has long been an important concern for consumers, particularly in the construction of permanent dwellings. However, recent spikes in fuel costs, and potential shortages of home heating oil have only heightened these concerns. One tool that consumers have employed to mitigate the resulting impacts is the use of insulation, which can be used not only in new construction, but in renovations as well. In particular, spray insulation foam is increasingly being used in such applications because of its excellent insulation properties and ability to block air movement. This material can be used to insulate, but also serves as a barrier to air, moisture and vapor, and can be used to seal attics, exterior walls and wall cavities. Increases in demand for polyurethane spray foam has spurred a corresponding desire among suppliers of foam precursors, such as polyester polyols, to improve their performance and cost effectiveness.

High functionality and/or high terephthalate content polyols with viscosities of 12000 cps or below, preferably <8000 cps, and in some cases <6000 cps are desirable in polyurethane applications, as these products allow formulators to process aromatic polyester polyols for PUIR/PIR systems with improved mechanical and burn resistance properties. Depending on product hydroxyl value, conventional aromatic polyester polyols can contain up to 25% residual monomer glycols depending on product hydroxyl values; and the presence of residual monomer glycols in the polyols results in lower viscosity products. In addition, formulators routinely employ the use of high equivalent weight glycols, such as triethylene glycol, tetraethylene glycols, PEG200, PEG400 and PEG600 to reduce the viscosity of aromatic polyester polyols with high functionality. In both cases, the presence of high residual monomer glycols and the use of high equivalent weight molecular weight glycols leads to reduced aromatic structure in polyols, which further results in inferior mechanical properties and less favorable burn performance for the subsequent foams.

For these reasons, work has been ongoing to improve polyol performance; e.g., U.S. Pat. No. 9,809,674, CN104262596, CN110563935, CN103724598 relate to high functional aromatic polyester polyols; U.S. Pat. Nos. 8,912,364, 5,689,012, 6,713,599, and 8,680,211 relate to narrow range molecular weight polyols; WO2010/051962, WO2010/142399, and U.S. Pat. No. 8,481,606 relate to low 1,4 dioxane polyester polyols. Nevertheless, a continuing need exists for polyol compositions that provide improved performance, especially in spray foam applications.

### SUMMARY

In conventional polyols, the presence of residual monomer glycols at levels of 10% provides for lower viscosity. The residual monomer glycols significantly add to the total hydroxyl value of the product and typically >35% of the product OH value of conventional aromatic polyester polyols arises from the OH's of the residual monomer glycols. Removing the residual glycol in the final product to levels of <10% and in some cases to levels of <5% lowers the OH value, however, this inevitably increases the product viscosity. Applicants have discovered low viscosity aromatic polyester polyol compositions having lower residual monomer glycols. Such polyol compositions possess higher polymer content and higher aromaticity, which provides better mechanicals and higher burn resistance for PU/PIR foams. Reducing the residual monomer glycols also lowers the overall OH values of the polyester polyol product. Lower OH products in PU/PIR applications are of interest to optimize MDI usage.

High functionality, high terephthalic acid (TA) containing polyols with viscosity lower than 10,000 cps are also desirable in polyurethane applications, as these products provide good mechanical properties and burn performance in PU and PIR systems. Conventionally made polyesters typically have viscosities higher than 10,000 cps (especially with functionalities above 2), so viscosity modifiers or excess glycols are added to manage the viscosities.

In one embodiment, the invention relates to aromatic polyester polyols comprising a total product OH value of 150 to 450; a viscosity of less than 12,000 cps; residual monomer glycols in an amount less than 10 wt %; total OH's from residual monomer glycols of <30% that of the total product OH value and a level of 1,4 dioxanes less than 50 ppm.

In another embodiment, the invention relates to a process for making low viscosity aromatic polyester polyol products. In a further embodiment, the invention relates to a process comprising: feeding a feed stream comprising a glycol stream, an aromatic stream comprising at least one of aromatic esters and acids, and a catalyst stream to a reactor, where the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof; and aromatic acids/esters selected from terepthalic acid, isophthalic acids, phthalic acids/anhydrides, trimellitic anhydrides and corresponding esters, or combinations thereof, reacting the feed stream in the reactor, thereby forming an intermediate product stream comprising water, glycols, optionally 1,4 dioxanes and aromatic polyester polyols having a total product OH value greater than 250. The intermediate product stream is separated by a thermal separation process under vacuum into a glycol enriched stream and a product stream having a total product OH value of less than 450, a viscosity of less than 12000 cps; and a level of residual monomer glycols at a level of less than 10 wt %. The intermediate product stream contains over 10-50% excess residual monomer glycol and preferably about 20-35% excess residual monomer glycols. Subsequently, the excess residual monomer glycols in the intermediate stream is removed by a thermal separation process under vacuum to generate a glycol overhead (ovh) stream which comprises primarily monomer glycol, and a bottoms stream which includes the low residual monomer glycols inventive polyol, as described above.

In a further embodiment, the invention relates to aromatic polyester polyols having 1,4 dioxanes levels of <50 ppm.

In a still further embodiment, the invention relates to a polyurethane foam comprising an aromatic polyester polyol, a surfactant, a catalyst, an isocyanate and a blowing agent, where the aromatic polyester polyol comprises a total OH product value of 150 to 450; a viscosity of less than 12,000 cps; residual monomer glycols less than 10 wt %; and a level of 1,4 dioxanes less than 50 ppm. Preferably, when the total product OH value is less than or equal to 220, the residual monomer glycols are less than 4 wt %; when the total product OH value is less than 280, the residual monomer glycols are less than 6 wt %, when the total product OH value is less than 350, the residual monomer glycols are less than 8 wt %; and when the total product OH value is less than 450, the residual monomer glycols are less than 10 wt %.

### BRIEF DESCRIPTION OF THE DRAWINGS

FIG. 1 shows a wiped film evaporator serving as the thermal separation device to remove excess glycol in an intermediate polyol product.

FIG. 2 illustrates a smoke tester for comparative smoke testing of polyurethane and polyisocyanurate foams.

FIG. 3 shows comparative green strength of foams produced from Inventive Polyols vs Commercial Polyols.

### DETAILED DESCRIPTION

The current subject matter is directed to low viscosity polyols having reduced levels of residual monomer glycols, where the OH values from the residual monomer glycols account for less than 30% of the total product hydroxyls. As shown in Table 1, typical aromatic polyester polyols in the market contain residual monomer glycols ranging from 7% to 20%, depending on the product OH value. While residual glycols in aromatic polyester polyols increase with product hydroxyl values, in all cases OH values from the residual glycols invariably account for greater than 35% of the product's total hydroxyls.

TABLE 1
Residual Monomer Glycols in Current Commercial Aromatic Polyester Polyols.

| | Terate ® HT | Stepanpol ® | Terate ® HT | Stepanpol ® | Terate ® HT | Stepanpol ® | Terol ® | Isoexter | Stepanpol ® |
|---|---|---|---|---|---|---|---|---|---|
| Polyol Parameters | 2000 | PS2352 | 5500 | PS2602 | 5510 | PS 3152 | 649 | TB375 | PS 3728 |
| Nominal Product | 2 | 2 | 2 | 2 | 2 | 2 | 2.8 | 2.8 | 2.8 |
| Functionality | | | | | | | | | |
| Residual Glycols | | | | | | | | | |
| % DEG | 7.3 | 9 | 9 | 11 | 10.5 | 15 | 3.7 | 5.6 | 7.1 |
| % Glycerine | | 0.5 | | | | | 2.8 | 4.1 | 3.9 |
| TEG | | | | | | | 7.4 | 1.3 | |
| TTEG | | | | | | | 4 | 2.2 | |
| Total Residual Glycols | 7.3 | 9.5 | 9 | 11 | 10.5 | 15 | 17.9 | 13.2 | 11 |
| Total OH from Residual | 77 | 104 | 95 | 116 | 111 | 158 | 169 | 157 | 146 |
| Glycols | | | | | | | | | |
| Product OH Value | 207 | 240 | 240 | 260 | 260 | 315 | 375 | 375 | 375 |
| % OH from free glycol | 37% | 43% | 40% | 45% | 43% | 50% | 45% | 42% | 39% |

The polyols of the current subject matter also offer improved fire performance and green strength. For polyester polyols made with diethylene glycol, the polyols of the current subject matter further possess low to no 1,4-dioxanes, a likely carcinogen, lower crystallization potential on storage, high PTA polyesters, and a path towards ultra-high (>3.0) functionality.

In one embodiment, the current invention relates to aromatic polyester polyols comprising a total product OH value of 150 to 450; a viscosity of less than 12,000 cps; OH's from residual monomer glycols of <30%; residual monomer glycols in an amount less than 10 wt %; and a level of 1,4 dioxanes less than 50 ppm.

Regarding characterization of the aromatic polyester polyols of the present subject matter, hydroxyl values or OH are reported as mg KOH/g and are measured according to the ASTM D6342 standard. Acid number is reported in terms of mg KOH/g and measured according to ASTM 4662 standard. Water content of the polyol is measured according to the ASTM D4672 standard. The viscosity of the polyol is measured at 25C using a Brookfield viscometer according to ASTM D4878.

For the purpose of this specification, the term “residual monomer glycols” includes the sum total of all the unreacted glycols used in the esterification process. Residual monomer glycols can be ethylene glycol, diethylene glycol, triethylene glycol, tetraethylene glycol, glycerine and other monomeric glycols used to make the polyol. The residual monomer glycols in the polyol can be measured using gas chromatographic methods with a flame ionization detector, using a DB-1 column and silating reagent to provide quantitative analyses for the residual glycols. The gas chromatographic method used for the analysis was standardized against relevant glycol standards. Gas chromatographic development for analyses of low molecular weight glycols such as ethylene glycol, diethylene glycol, triethylene glycol, tetraethylene glycol, glycerine, etc with silating reagents are known in the art and can easily be developed by experts and/or competent personnel in the art.

Preferably, the total product OH value of the aromatic polyester polyol is less than 200 and the viscosity is less than 10,000 cps at 25° C., preferably, less than 8000 cps at 25° C. Preferably, the aromatic polyester polyol has a functionality between 2.2 and 3.5 with a total product OH value of <400 mg KOH/gram sample and product viscosity of less than 12000 cps at 25° C., preferably less than 8000 cps at 25° C.

Preferably, the aromatic polyester polyol does not contain flame retardants and/or other additives which lower the product viscosity and/or product hydroxyl values. For the purpose of this specification, the term flame retardants includes solid or liquid compounds containing phosphorus, chlorine, bromine, boron, nitrogen or combinations of these elements. Examples include brominated phthalate diols, ammonium polyphosphates, triethyl phosphate, tris(2-chloroisopropyl) phosphate, tetrakis(2-chloroethyl)ethylene diphosphate, tris(β-chloroethyl) phosphate, tris(2,3-dibromopropyl) phosphate, and the like. The term additive includes diluents such as propylene carbonate, dimethyl basic esters (DBE), non-ionic surfactants and the like, designed to lower the viscosity of the polyol.

Preferably, the aromatic polyester polyol has an average functionality or average hydroxyl function of greater the 1.9, preferably between 1.95 and 3.5 with a viscosity of less than 12,000 cps. The term “average functionality,” or “average hydroxyl functionality” of a polyol indicates the number of —OH groups per molecule, on average. One way to determine the average functionality is by measuring the average molecular weight of polyol (Mn) by gel permeation chromatography. The average functionality is:

$$Average Functionality = Polyol Equivalent Weight ( Eqwt ) / Mn$$

where Eqwt=56, 100/OH number of polyol, and Mn is the average molecular weight of the polyol.

Preferably, when the total product OH value of the aromatic polyester polyol is less than 220, the residual monomer glycols are less than 4 wt %.

Preferably, when the total product OH value of the aromatic polyester polyol is less than 280, the residual monomer glycols are less than 6 wt %.

Preferably, when the total product OH value of the aromatic polyester polyol is less than 350, the residual monomer glycols are less than 8 wt %;

Preferably, when the total product OH value of the aromatic polyester polyol is less than 450, the residual monomer glycols are less than 10 wt %.

In a further embodiment, the invention relates to a process comprising: feeding a feed stream comprising a glycol stream, an aromatic stream comprising at least one of aromatic esters and acids, and a catalyst stream to a reactor, where the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof; and the aromatic acids/esters selected from terepthalic acid, isophthalic acids, phthalic acids/anhydrides, trimellitic anhydrides and corresponding esters, or combinations thereof, reacting the feed stream in the reactor, thereby forming an intermediate product stream. The intermediate product stream contains 10-50% residual monomer glycol and preferably about 20-35% residual monomer glycols. The residual monomer glycols in intermediate product stream are subsequently separated-by a thermal separation process under vacuum into a glycol enriched stream and the product stream which is the inventive aromatic polyester polyol having a total product OH value of less than 450, a viscosity of less than 12000 cps; and a level of residual monomer glycols less than 10 wt %.

Preferably, in the process the feed stream further comprises hydroxyl terminated materials in the glycol stream, and the acid stream further comprises at least one of aliphatic acids/esters, fatty acids/oils or combinations thereof. Aliphatic acids can contain succinic acid, glutaric acids, adipic acids and/or esters thereof and/or combinations in the acid stream.

Preferably, in the process the hydroxyl terminated materials are alkanolamines selected from diethanolamine, triethanolamine, substituted ethanolamines or mixtures thereof.

Preferably, in the process the aliphatic acids are selected from succinic acid, glutaric acids, adipic acids, esters thereof or combinations thereof.

Preferably, the ratio of the glycol stream to the aromatic stream is 2.4 to 4.

Preferably, the reaction is conducted at a reaction temperature of 180° C. to 235° C.

Preferably, the vacuum separation is conducted at temperatures of 130° C. to 170° C. and pressures of 0.1 mmHG to 20 mmHG.

In the reaction to form the intermediate polyol, the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof.

The glycol stream is preferably selected from monoethylene glycol, diethylene glycol, propylene glycol, triethylene glycol, tetraethylene glycol, polyethylene glycol or mixtures thereof. More preferably, the glycol stream is selected from diethylene glycol and polyethylene glycol. For making polyols with functionality higher than 2, triols and higher functionality alcohols can be added, including glycerine, trimethylol, pentaerythritol, glucosides and alkylsubstituted glucosides.

In the reaction to form the intermediate polyol, other hydroxyl terminated materials can also be added or used in the feed stream, such as alkanolamines including diethanolamine, triethanolamine, substituted ethanolamines, etc.

The process can also further comprise hydroxyl terminated materials in the feed stream, and/or at least one of aliphatic acids/esters, fatty acids and natural oils or combinations thereof. Aliphatic acids can contain succinic acid, glutaric acids, adipic acids and/or esters thereof and/or combinations in the acid stream.

The aromatic acids/esters in the aromatic stream are preferably selected from terephthalic acids, phthalic anhydride, isophthalic acid, trimellitic anhydrides and/or esters and/or intermediates and/or byproducts from production of these acids/esters, thereof. More preferably, the aromatic esters are selected from terephthalic acids, phthalic anhydride and/or esters thereof. In the reaction to form an intermediate polyol, other modifiers such as aliphatic acid and/or fatty acid/oil derivatives can be used as hydrophobic reactants for making polyols. Preferably, the aliphatic acids/esters are selected from succinic acid, glutaric acids, adipic acids and/or esters thereof and/or combinations thereof. Fatty acids include, for instance, caproic acid, caprylic acid, capric acid, lauric acid, myristic acid, palmitic acid, stearic acid, oleic acid, linoleic acid, ricinoleic acid, and the like, and mixtures thereof. Fatty acid esters include, e.g., fatty methyl esters such as methyl laurate, methyl palmitate, methyl oleate, and the like. Fatty alcohols include, e.g., decyl alcohol, oleyl alcohol, dodecyl alcohol, tridecyl alcohol, and the like. Natural oils include, e.g., soybean oil, sunflower oil, castor oil, corn oil, olive oil, palm oil, tall oil, tallow, and the like. Alkylphenols include, e.g., octylphenols, nonylphenols, decylphenols, dodecylphenols, and the like.

A catalyst is used in the reaction to form the intermediate polyol. Preferably, the catalyst is selected from, but not limited to, titanates such as tetrabutyl titanates, tetraisopropyl titanates, and metal-based oxides such as dibutyl tin oxides, oxides of lead, oxides of antimony, and combinations thereof. Other catalysts, including alkali metal catalysts or Lewis or Bronsted acids, can also be used.

The reaction to form the intermediate polyol is an esterification and/or transesterification reaction conducted at temperatures between 180 to 250° C., preferably between 21° and 230° C. The reaction is carried out in the presence of the catalyst described above, typically in the range of 10 to 2000 ppm, more preferably, between 200 to 600 ppm.

The reactor in which the reaction to make the intermediate polyol is conducted is a closed vessel that is configured and selected to safely accommodate consistent stirring and nitrogen sparge of reactants and/or reaction mix, minimal loss of reactants and to quantitively obtain the byproducts generated, such as water, during the reaction. The reaction vessel is affixed with mechanical stirring, nitrogen inlet, packed column, condenser with receiver and temperature controls to monitor reactor and overhead temperatures. Esterification/transesterification reaction procedures and condition for the reaction are known in the art (See, U.S. Pat. No. 3,647,759, the disclosure of which is herein incorporated by reference).

The intermediate product stream resulting from the esterication/transesterication contains hydroxyl terminated oligomers and high levels of residual monomer glycols, where the total product OH value of the intermediate product is >250 mgKOH/gram sample. If diethylene glycol is used as a monomer, 1,4-dioxane can also be present in the intermediate product stream. Depending on the initial glycol to acid ratio used in the reaction, the intermediate polyol can contain as high as 50% or more of the residual monomer glycols. The intermediate product stream is then subjected to a thermal separation carried out at temperatures less than 200° C., preferably at temperatures between 14° and 180° C. The molecular weight (MW) distribution of the low glycol product in the bottom stream can be controlled by varying the glycol/acid ratio during the esterification/transesterification process, varying separation temperatures and/or a ratio of the overhead and bottoms stream of the thermal separation process, and then stripping excess glycol at temperatures less than 200° C. under vacuum. Preferably, the ratio of the glycol stream to the aromatic stream is 2.0 to 4.0.

### Thermal Separation Process Under Vacuum

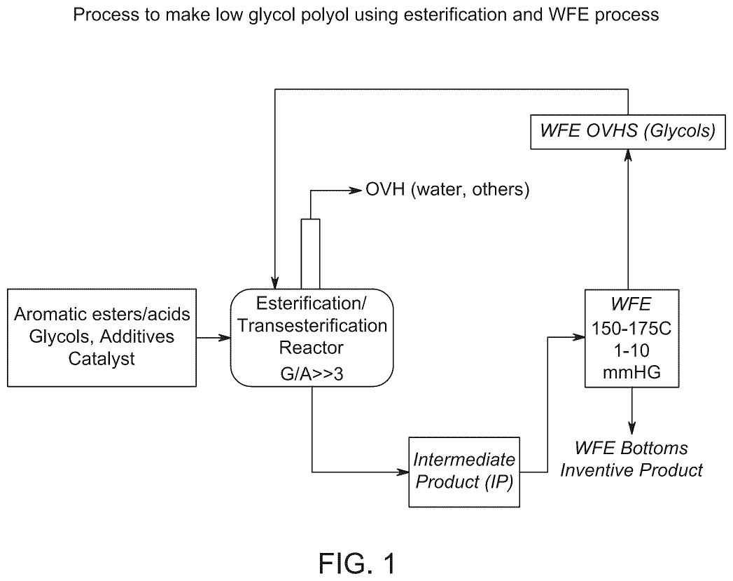

The thermal separation process under vacuum at less than 200° C. serves to remove the excess glycol from the polyester polyols. It can also be used to remove unwanted contaminants such as 1,4-dioxanes. This thermal separation process can include the use of wiped film evaporators (WFE), molecular still distillation (MSD), vacuum distillation, and short path molecular distillation equipment. The use of WFE's and MSD's is preferred. FIG. 1 illustrates a process to make residual monomer glycols polyol using an esterification process, where a WFE is employed to separate volatile compounds and the unreacted glycolic monomers. In the WFE process, a mechanically agitated thin film of feed material is introduced to a heated surface under vacuum for efficient removal of residual monomeric glycols at lower temperatures (less than 200° C.) and for short residence time. Both the operating temperature and the low residence time minimize the total heat exposure to the product, preventing excessive thermal degradation and minimizing the generation of higher molecular weight oligomers, which lead to higher viscosity in polyol products. The temperature of the thermal separation process is preferably from 130 to 170° C. The pressure of the thermal separation process is preferably from 0.1 mm Hg to 20 mm Hg.

When using diethylene glycol in the production of intermediate product, 1,4-dioxane is produced as a byproduct. 1,4 dioxane is a hazardous byproduct that is created during the esterification process. In the process of removing the monomeric diethylene glycol in the intermediate product, 1,4-dioxanes produced in the process are also stripped overhead, and this provides a low 1,4-dioxane-containing polyol in the bottom stream which is the final product The resulting polyester polyol has a total product OH value of less than 400, a viscosity of less than 15,000 cps, and a level of residual monomer glycols at a level of less than 10 wt %. Preferably, when the total product OH value of the aromatic polyester polyol is less than or equal to 220, the residual monomer glycols are less than 4 wt %, when the total product OH value is less than 280, the residual monomer glycols are less than 6 wt %, when the total product OH value is less than 350, the residual monomer glycols are less than 8 wt %, and when the total product OH value is less than 450, the residual monomer glycols are less than 10 wt %. Preferably, the polyester polyol has a 1,4 dioxane level of <50 ppm or is nondetectable.

In still another embodiment, the invention relates to a polyurethane and/or polyisocyanurate foam comprising an aromatic polyester polyol, a surfactant, a catalyst an isocyanate and a blowing agent, where the aromatic polyester polyol comprises a total product OH value of 150 to 450; a viscosity of less than 12,000 cps; total OH values from residual monomer glycols of <30%; residual monomer glycols in an amount less than 10 wt %; and a level of 1,4 dioxanes less than 50 ppm.

In another embodiment, the invention relates to an aliphatic polyester polyol or a mixed aliphatic/aromatic polyester polyol comprising a total product OH value of <120; a viscosity of less than 20,000 cps; an OH value from residual monomer glycols of <5% of the total product OH value; and residual monomer glycols in an amount of less than 1%.

Preferably, when the aliphatic polyester polyol or the mixed aliphatic/aromatic polyester polyol has a total product OH value of less than 80, the residual monomer glycols are less than 0.5 wt %. More preferably, the residual monomer glycols are less than 0.2 wt %, and the viscosity is <18000 cps.

Preferably, the aliphatic polyester polyol or the mixed aliphatic/aromatic polyester polyol has a functionality of 1.9 to 4.

The aliphatic polyester polyol or the mixed aliphatic/aromatic polyester polyol can be produced by feeding a feed stream comprising a glycol stream and an aromatic stream comprising at least one of aliphatic and/or aromatic esters and acids, and a catalyst stream to a reactor where the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof. The aliphatic acids/ester and/or aromatic acids is selected from succinic acid, glutaric acids, adipic acids, terepthalic acid, isophthalic acids, phthalic acids/anhydrides, trimellitic anhydrides and other diacids/polyacid and corresponding esters, or combinations thereof. The feed stream is reacted in the reactor to form an intermediate stream with residual monomer glycols of more than 0.8% and preferable of more than 1.5%. Finally, the excess residual monomer glycols in the intermediate stream is removed by a thermal separation process under vacuum into the overhead stream which is glycol enriched stream and the bottoms stream which is the inventive aliphatic polyester polyol or mixed aliphatic/aromatic polyester polyol.

In still another embodiment the invention relates to a polyurethane flexible foam comprising the inventive aliphatic polyester polyol or the mixed aromatic polyester polyol, a surfactant, a catalyst, an isocyanate.

### Isocyanates

The isocyanates suitable for use are well known, and many are commercially available from Dow Chemical (under the PAPI™, ISONATE®, and VORONATE™ marks), Evonik (VESTANAT®), BASF (LUPRANATE®), Covestro (MONDUR® and DESMODUR®), Huntsman (RUBINATE®), and other suppliers of polyurethane intermediates. Isocyanates suitable for use have average NCO functionalities (reactive groups per molecule) within the range of 2.0 to 3.0. The isocyanate can be aromatic or aliphatic. Aromatic isocyanates include, e.g., toluene diisocyanates (TDI), 4,4′-diphenylmethane diisocyanates (MDI), or polymeric diisocyanates (p-MDI), or the like. Aliphatic isocyanates include, e.g., hexamethylene diisocyanate (HDI), hydrogenated MDI, cyclohexane diisocyanate (CHDI), isophorone diisocyanate (IPDI), trimethyl or tetramethylhexamethylene diisocyanate (TMXDI), or the like. Aromatic isocyanates, especially polymeric MDIs having NCO functionalities within the range of 2.3 to 3.0, are preferred. Suitable polymeric MDIs include, for instance, LUPRANATE® M-10 (average NCO functionality=2.3) and LUPRANATE® M-20 (average NCO functionality=2.7), products of BASF, as well as MONDUR® 489 (modified polymeric MDI, average NCO functionality=2.9), product of Covestro. Mixtures of different isocyanates can be used. Dimerized and trimerized isocyanates can be used. In some aspects, aromatic isocyanates, e.g., p-MDI, are preferred.

### Blowing Agents

Blowing agents can include aliphatic or cycloaliphatic C₄-C₆ hydrocarbons, water, mono- and polycarboxylic acids and their salts, tertiary alcohols, chlorofluorocarbons (CFCs), hydrochlorofluorocarbons (HCFCs), halogenated hydrocarbons, hydrofluoroolefins (HFOs), and the like, and their mixtures. For further examples of suitable blowing agents, see U.S. Pat. No. 6,359,022, the teachings of which are incorporated herein by reference.

### Surfactants

Surfactants are used in the process for producing a rigid PUR or PIR foam to enable the production of a closed-cell rigid foam. Representative examples include products available commercially from Evonik, Dow Chemical, Siltech, Momentive Performance Materials, and in particularly include TEGOSTAB® B silicone surfactants (Evonik), SILSTAB® silicone surfactants (Siltech), VORASURF™ surfactants (Dow), NIAX® surfactants (Momentive) and others. Other suitable surfactants are polysiloxanes or other silicon-based surfactants.

### Catalysts

Catalysts suitable for use include compounds that catalyze the reaction of isocyanates and water (“blowing catalysts”) and compounds that catalyze the formation of urethane, urea, or isocyanurate linkages (“PU catalysts,” “PIR catalysts,” or “trimerization catalysts”).

Amine catalysts are generally tertiary amines or alkanolamines and their mixtures with a diluent, typically a glycol such as dipropylene glycol. Examples include bis(2-dimethylaminoethyl) ether, N,N-dimethylaminopropylamine, N,N-dimethylethanolamine, triethylenediamine, benzyldimethylamine, N,N-dimethylcyclohexylamine, N,N,N′,N′,N″-pentamethyldiethylenetriamine (PMDETA), diethanolamine, N-ethylmorpholine, N,N,N′N′-tetramethylbutanediamine, 1,4-diaza[2.2.2]bicyclooctane, and the like, and combinations thereof. Examples also include POLYCAT® 5 or POLYCAT® 8 (Evonik) and NIAX® A-1 or NIAX® A-99 (Momentive).

Other catalysts include carboxylates (e.g., potassium acetate, potassium octoate), organotin compounds (e.g., dibutyltin dilaurate, stannous octoate), quaternary ammonium compounds (e.g., N-(2-hydroxyethyl)trimethylammonium chloride), and the like, and combinations thereof.

Suitable catalysts are available from Evonik (TEGOAMIN® amine catalysts, KOSMOS® metal catalysts, DABCO® TMR catalysts, DABCO® K-15 catalysts, and POLYCAT® catalysts), Huntsman (JEFFCAT® catalysts), King Industries (K-KAT® catalysts), Momentive (NIAX® catalysts), Galata Chemicals (FOMREZ® organotin catalysts), and others.

### Blowing Agents

When blowing agents are used in the process for producing a rigid PUR or PIR foam, the blowing agents can include aliphatic or cycloaliphatic C₄-C₆ hydrocarbons, water, mono- and polycarboxylic acids and their salts, tertiary alcohols, chlorofluorocarbons (CFCs), hydrochlorofluorocarbons (HCFCs), halogenated hydrocarbons, hydrofluoroolefins (HFOs), and the like, and their mixtures. For further examples of suitable blowing agents, see U.S. Pat. No. 6,359,022, the teachings of which are incorporated herein by reference.

### EXAMPLES

The following Examples further detail and explain the inventive process. These examples merely illustrate the invention. Those skilled in the art will recognize many variations that are within the spirit of the invention and scope of the claims.

### Example 1

Table 2 shows a comparative profile of an inventive low residual monomer glycol polyester polyol, (Sample 1), vs a prior art polyol (Sample 2) based on equivalent recipes. As shown, the total residual monomer glycol in the inventive polyol having a total product OH value of 378 is about 5% vs 15% residual present in Sample 2, typical of commercial products with total product OH value of greater than 350. The total OH contribution from residual monomer glycols in the inventive polyol is less than 25% of the total product OH value.

TABLE 2
Inventive polyol vs Conventional Polyol
based on the same composition

| | Sample 1 | |
|---|---|---|
| | (INVENTIVE | Sample 2 |
| Reactants of the polymer | POLYOL) | (Prior Art) |
| Terephthalic Acid | 33.4 | 33.3 |
| Phthalic Anhydride | 4.3 | 4.3 |
| COP | 0.0 | 0.0 |
| Adipic Acid | 4.3 | 4.3 |
| Glycerine | 16.0 | 15.6 |
| PE | 0.0 | 0.0 |
| Diethylene Glycol | 33.0 | 33.5 |
| Polyethylene Glycol | 9.1 | 9.1 |
| OH Value, mg KOH/gram sample | 378 | 377 |
| Viscosity | 8096 | 15540 |
| Product Functionality | 2.70 | 2.70 |
| OH Value, mg KOH/gram sample | 1.1 | 1.65 |
| Total Residual Monomeric Gycol | 5% | 15% |
| Total OH from free glycol | 88.6 | 180.2 |
| % OH from free glycol | 23% | 48% |

Sample 1 was prepared according to the process flow shown in FIG. 1. The weights of the raw materials to make the Intermediate Product for Sample 1 are listed in Table 3. 550 grams of PTA, 70 grams of phthalic anhydride, 70 grams of adipic acid, 800 grams of diethylene glycol and 0.6 grams of catalyst was initially charged into a 5-liter glass reactor affixed with mechanical stirring, nitrogen inlet, packed column, condenser with receiver and temperature controls to monitor reactor and overhead temperatures. The reaction was carried to 230° C. and the water byproduct was collected in the receiver. When the reaction mix became free of solids, glycerine, and polyethylene glycol, the remainder of diethylene glycol was added, and the reaction was continued at 230° C. until a target of less than 1 mgKOH/gram sample acid number was achieved. At the end of the esterification process, the Intermediate product showed a viscosity of less than 1000 cps and contained >25% of unreacted DEG and glycerine. The excess of unreacted DEG and glycerine in the Intermediate product was removed using a wiped film evaporator (WFE) at 170° C. and 5 mmHg vacuum conditions. The WFE conditions are listed in Table 3. The Inventive Polyol Sample 1 was the WFE bottoms, which corresponds to the Intermediate Product after selectively stripping residual monomer glycols to the overhead. Table 3c shows the calculated raw materials based on the total diethylene glycol and glycerine quantities removed to the WFE overheads. The calculated functionality of the Inventive Polyol (Sample 1) is 2.7.

Sample 2 was prepared using reactions conditions currently used to produce commercial aromatic polyester polyols. 550 grams of PTA, 70 grams of phthalic anhydride, 70 grams of adipic acid, 511 grams of diethylene glycol, 150 grams of polyethylene glycol, 244 grams of glycerine and 0.6 grams of catalyst was initially charged into a 3-liter glass reactor affixed with mechanical stirring, nitrogen inlet, packed column, condenser with receiver and temperature controls to monitor reactor and overhead temperatures. The reaction mix was heated to 230° C. and the water byproduct was collected in the receiver. As shown in Table 2, at the same total product OH value, the viscosity of the Inventive Polyol is much lower compared to that of Sample 2 prepared with residual glycols typical of commercial products. The Inventive Polyol Sample 1 also shows lower levels of residual monomer glycols.

TABLE 3
Inventive Polyol (Example 1)- From Intermediate
Product to Final Product (WFE Bottoms)

| Table 3a. Raw | Terephthalic Acid | 550 | |
|---|---|---|---|
| Materials in | Phthalic Anhydride | 70 | |
| the Intermediate | Adipic Acid | 70 | |
| Product | Glycerine | 582 | |
| | Diethylene Glycol | 1062 | |
| | Polyethylene Glycol | 150 | |
| | Catalyst | 0.62 | |
| | Yield | 2485 | |
| Table 3b. WFE | WFE Strip Conditions | | |
| Conditions | WFE Temperature | 170 | C. |
| | WFE Vacuum Conditions | 5 | mmHG |

| | % WFE ovh | 35.8% |
|---|---|---|
| | % Gly | 38% |
| | % DEG | 62% |
| | Total glycerine loss to WFE Ovh | 338 |
| | Total diethylene loss to WFE Ovh | 551 |
| Table 3c. | Terephthalic Acid | 550 |
| Calculated Raw | Phthalic Anhydride | 70 |
| materials in | Adipic Acid | 70 |
| WFE Bottoms | Glycerine | 244 |
| (Sample 1) | Diethylene Glycol | 511 |
| | Polyethylene Glycol | 150 |
| | Catalyst | 0.62 |
| | Yield | 1450 |

### Example 2

5817 grams of PTA, 687 grams of phthalic anhydride, and 8000 grams of diethylene glycol were initially charged to a 30 liter reactor equipped with mechanical stirring, nitrogen inlet, packed column, condenser with receiver and temperature controls, to monitor reactor and overhead temperatures. The reaction was carried to 230° C. in the presence of esterification catalyst and the water byproduct was collected in the receiver. When the reaction mix became free of solids, 2466 grams glycerine, 1080 grams polyethylene glycol and 4654 grams diethylene glycol were added, and the reaction was continued at 230° C. until a target of less than 1 mgKOH/gram sample was achieved. After the esterification reaction, the resulting intermediate product was cooled and charged into the WFE set-up. The excess of unreacted DEG and glycerine in the Intermediate product was removed at 170° C. and 5 mmHg vacuum conditions. The WFE conditions are listed in Table 4c. The Inventive Polyol is the WFE bottoms, after thermal separation of the excess glycol in the Intermediate Product. Table 4d shows the calculated raw materials based on the total diethylene glycol and glycerine quantities removed remaining in the WFE bottoms. The calculated functionality of the Inventive Polyol (Example 2) is about 2.4. As shown in Table 4, the Inventive Polyol Example 2 uniquely contains low residual monomer glycols significantly lower than the residual monomer glycols in commercial products shown in see Table 1. At a total product hydroxyl value of 310, the residual monomer glycol in Example 2 is less than 5%, and the total OH contribution of the residual monomer glycols in the total OH's in the product is less than 20%.

TABLE 4
Inventive Polyol (Example 2)

| INVENTIVE Polyol - | OH Value | 310 | |
|---|---|---|---|
| Example 2 | Viscosity | 8513 | |
| | % DEG | 1.8 | |
| | % Gly | 1.1 | |
| | Product functionality | 2.4 | |
| | Total residual monomer glycol | <5% | |
| | Total OH from residual | 39.1 | |
| | monomer glycol | | |
| | % OH from residual monomer | 13% | |
| | glycol | | |
| Table 4a. Raw | PTA | 5817 | |
| Materials in the | PA | 687 | |
| Intermediate | Glycerin | 2466 | |
| Product | DEG | 12654 | |
| | PEG600 | 1080 | |
| Table 4b. Quantity | PTA | 27.2 | |
| of Raw Materials | PA | 3.2 | |
| per hundred part | Glycerin | 11.5 | |
| (php) Intermediate | DEG | 59.2 | |
| Product | PEG600 | 5.1 | |
| Table 4c. WFE | WFE Strip Conditions | | |
| Conditions | WFE Temperature | 150 | C. |
| | WFE Vacuum Conditions | 5 | mmHG |

| | % WFE Strip to Ovh | 36.2% |
|---|---|---|
| | % Gly | 16% |
| | % DEG | 83% |
| Table 4d. Calculated | Total glycerine loss | 5.8 |
| Raw materials php | Total DEG loss | 30.1 |
| WFE Bottoms | PTA | 41.3 |
| | PA | 4.9 |
| | Glycerin | 9.1 |
| | DEG | 46.6 |
| | PEG600 | 7.7 |
| | Yield | 100.0 |

### Example 3

Table 5 shows the product profile of low viscosity low hydroxyl polyols with nominal functionalities of 2 and 2.1, with a total product OH value of less than 210. The low OH material is made with terephthalic acid, phthalic anhydride, adipic acid, diethylene glycol and a minimal amount of polyethylene glycol. To functionalize the low OH polyol, glycerine can be added as shown in Example 4. In both examples, the Intermediate Products were formed after esterification of the acids with DEG and/or glycerine at 225° C. at a glycol/acid ratio of about 2. Thermal separation of residual glycol was carried out in an WFE at 170° C. and 4 mmHG. The resulting product in the WFE streams contained low residual monomer glycol at less than 3% and OH contribution to the total product OH's are less than 20% in both cases.

TABLE 5
Inventive Polyols with OH values between 180 and 210

| Corrected | INVENTIVE Polyols - | OH Value | 181 | | 205 | |
|---|---|---|---|---|---|---|
| WFE Feed | Examples 3 and 4 | Viscosity | 4868 | | 4627 | |
| | | % DEG | 2.6 | | 1.3 | |
| | | Glycerine | 0 | | 0.1 | |
| | | Product functionality | 2 | | 2.1 | |
| | | Total OH from residual monomer glycol | 27 | | 16 | |
| | | % OH from residual monomer glycol | 15% | | 8% | |
| | Table 5a. Raw | Terephthalic Acid | 595 | | 595 | |
| | Materials in the | Phthalic Anhydride | 229 | | 229 | |
| | Intermediate | Adipic Acid | 168 | | 169 | |
| | Product | TOFA | 69 | | 0 | |
| | | SBO | 0 | | 69 | |
| | | Glycerin | 0 | | 30 | |
| | | Diethylene Glycol | 1393 | | 1393 | |
| | | PEG600 | 110 | | 110 | |
| | | Yield | 2252 | | 2286 | |
| WFE BTM | Table 5b. WFE | WFE Temperature | 170 | C. | 165 | C. |
| Comp | Conditions | WFE Vacuum Conditions | 4 | mmHg | 4 | mmHg |

| % WFE Strip to Ovh | 18.4% | 18.4% |
|---|---|---|
| % DEG in WFE OVH | 99% | 99% |
| Total DEG in WFE OVH | 410 | 417 |
| Terephthalic Acid | 595 | 595 |
| Phthalic Anhydride | 229 | 229 |
| Adipic Acid | 168 | 169 |
| TOFA | 69 | 0 |
| SBO | 0 | 69 |
| Glycerin | 0 | 30 |
| Diethylene Glycol | 983 | 975 |
| PEG600 | 110 | 110 |
| Yield | 1951 | 1979 |

### Example 4. Comparative Foam Testing of Samples 6 to 12

Closed cell polyurethane foams were produced from Inventive polyols to obtain comparative performance against prior art polyols, including the commercial products listed in Table 1 and/or polyols made in the laboratory outside the scope of the present invention. The polymeric MDI used in this study, or the A-side, is Rubinate M (Huntsman) having an NCO content of 31.2%, functionality of 2.7, and viscosity of 190 cps at 25° C. A polyol blend (or B-side) containing aromatic polyester and/or polyether polyols, flame retardants, surfactant, catalysts, blowing agent, and water was prepared. Both A-side and the B-side were precooled to 20° C. or a lower temperature such as 15° C. or 18° C. for a minimum of 1 hour. After temperature equilibration, A and B sides were subsequently combined in properly sized mixing cup at a 1:1 weight ratio of A and B-side. The combined mixture was agitated for 3-5 seconds using a motor driven mixing blade rotating at 3500 rpm and poured into an appropriate box based on the total weight of the foam. The reactivity profiles were obtained by measuring cream time, string gel time and tack free time.

Table 6 lists the various Inventive polyols that were used to generate hand mix foams for comparative foam performance studies against currently available commercial products shown in Table 1 in hand mix spray formulations. For Samples 6, 7, 9, 10, 11, and 12, intermediate products were first produced using a similar set-up described in the preparation of Sample 1, and residual monomer glycols were thermally removed under vacuum to generate aromatic polyester polyols with low residual monomer glycols. The residual monomer glycols of the inventive polyol samples (Samples 6,7,9,10,11,12) are shown in Table 6. These inventive polyols contain low residual glycols with an OH contribution form residual glycols less than 20%. Sample 8, which is not an Inventive polyol, was made using similar methodology for making Sample 2

TABLE 6
Other Examples of Inventive Polyols

| | Inventive | Inventive | | Inventive | Inventive | Inventive | Inventive |
|---|---|---|---|---|---|---|---|
| | Polyol - | Polyol - | | Polyol - | Polyol - | Polyol - | Polyol - |
| Polyol Parameters | Sample 6 | Sample 7 | Sample 8 | Sample 9 | Sample 10 | Sample 11 | Sample 12 |
| OH Value | 343 | 371 | 350 | 305 | 310 | 306 | 310 |
| Viscosity | 8705 | 9750 | 8500 | 10960 | 8513 | 9524 | 9570 |
| % DEG | 1.3% | 2.8% | 8.9% | 0.7% | 1.8% | 1.9% | 2.1% |
| % Gly | 2.6% | 3.3% | 1.1% | 0.4% | 1.1% | 0.5% | 0.8% |
| % Other Residual Glycols | None | None | >3% | None | None | None | None |
| Residual Glycol | 4% | 6% | 10% | 1% | 3% | 2% | 3% |
| % OH from Residual glycol | 18% | 24% | >40% | 5% | 13% | 10% | 12% |

Samples 6-12 were used to prepare hand mix foams using typical spray formulations wherein the A-side, which is the isocyanate, was mixed with the B-side on a 1:1 weight ratio. Descriptions of the various B-sides used to make handmix spray foams are listed in Table 7. To prepare the foams, the combined A and B-side mix was agitated for 3-5 seconds using a motor driven mixing blade rotating at 3500 rpm and poured into an appropriate box based on the total weight of the foam.

TABLE 7
B-side formulations used for hand mix foams

| Aromatic | | | | | | | |
|---|---|---|---|---|---|---|---|
| Polyester | Formulation | Formulation | Formulation | Formulation | Formulation | Formulation | Formulation |
| Polyol | 1 | 2 | 3 | 4 | 5 | 6 | 7 |
| POLY1 | 50.0 | 52.5 | 53.0 | 54.8 | 51.2 | 52.5 | 56.7 |
| Polyether 1 | 14.0 | 15.0 | 15.0 | 14.0 | 12.0 | 12.0 | 15.0 |
| Polyether 2 | 6.0 | 6.0 | 6.0 | 6.0 | — | — | 5.0 |
| Polyether 3 | — | — | — | — | 10.0 | 10.0 | — |
| DBE | — | — | — | — | 2.0 | 2.0 | — |
| FR1 | 5.0 | 3.0 | 1.5 | 3.0 | 4.0 | 4.0 | 3.0 |
| FR2 | 7.0 | 7.0 | 7.0 | 7.0 | 6.0 | 6.0 | 6.5 |
| FR3 | — | — | 1.5 | — | — | — | — |
| Catalysts | 3.1 | 3.1 | 3.1 | 3.2 | 2.9 | 2.9 | 3.1 |
| Surfactant | 1.1 | 1.1 | 1.1 | 1.1 | 1.5 | 1.5 | 1.1 |
| OPTEON 1100 | 12.0 | 10.5 | 10.5 | 9.0 | — | — | — |
| Solstice | — | — | — | — | 9.0 | 7.5 | 8.0 |
| Water | 1.9 | 1.8 | 1.8 | 2.0 | 1.4 | 1.6 | 1.6 |

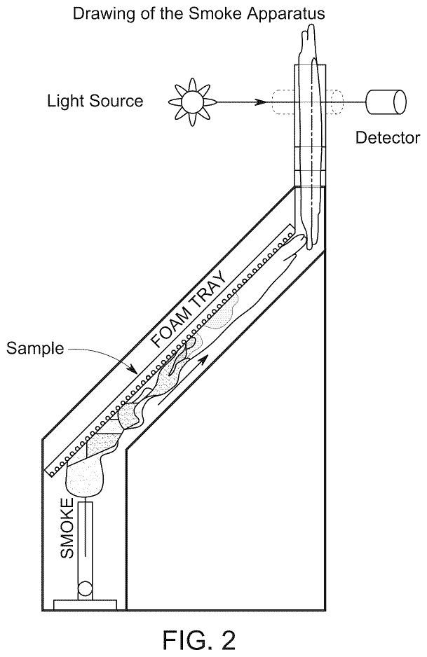

The comparative smoke profiles of foams made with Inventive polyols vs commercial polyols (see Tables 1 and 6) were tested using an in-house bench scale test device. The test apparatus is shown in FIG. 2. A foam specimen is placed at a fixed 45 degree angle with a Bunsen burner at the lower end of the specimen. The flame is applied at the surface of the foam specimen for a certain period of time. The smoke generated in the test travels by air flow through the tunnel and is measured by a photometer, or smoke detector, positioned at the higher end of the tunnel. The signal from the detector is simultaneously collected by a computer in order to process data further. The apparatus allows the comparative measurements of smoke profiles of foams systems made from different polyols at a given burn condition. Unless otherwise specified, the test results reported in Table 8 are average values from three to four test runs.

TABLE 8
Comparative Reactivity, Density and smoke data of Inventive Polyols
vs Commercial products based on Various Spray formulation platform

| | Formulation 1 | | | | | | | | | Formulation 4 | | |
|---|---|---|---|---|---|---|---|---|---|---|---|---|
| Aromatic | Terate | ISO- | | Formulation 2 | | | Formulation 3 | | | Terate | | Terate |
| Polyester | HT | EXTER | Sam- | Sam- | PS | Sam- | Sam- | Sam- | TEROL | HT | Sam- | HT |
| Polyol | 5100 | 375 | ple 6 | ple 7 | 3728 | ple 8 | ple 7 | ple 8 | 649 | 5345 | ple 9 | 5360 |
| WFE Product? | No | No | Yes | Yes | No | No | Yes | No | No | No | Yes | No |
| Reactivity | | | | | | | | | | | | |
| Profiles, secs | | | | | | | | | | | | |
| Cream Time | 7 | 6 | 7 | 7 | 8 | 7 | 8 | 7 | 8 | 6 | 6 | 7 |
| String Time | 16 | 18 | 17 | 21 | 19 | 18 | 20 | 18 | 17 | 17 | 21 | 18 |
| Tack Free Time | 27 | 24 | 26 | 28 | 25 | 24 | 27 | 24 | 21 | 29 | 29 | 26 |
| Foam Densities | 2.16 | 2.35 | 2.32 | 1.98 | 1.97 | 2.02 | 1.98 | 1.99 | 1.93 | 1.99 | 2.00 | 1.97 |
| Smoke Values | | | | | | | | | | | | |
| Test 1 | 3723 | 3757 | 3017 | 2273 | 3394 | 2920 | 2043 | 2776 | 2715 | 2015 | 1465 | 1585 |
| Test 2 | 3752 | 3998 | 3139 | 2161 | 3187 | 2915 | 2028 | 2617 | 2372 | 1834 | 1288 | 1691 |
| Test 3 | 3580 | 3740 | 3000 | 2385 | 3115 | 2961 | 2037 | 2477 | 2627 | 1760 | 1428 | 1723 |
| Average Smoke | 3685 | 3832 | 3052 | 2273 | 3232 | 2932 | 2036 | 2623 | 2571 | 1870 | 1394 | 1667 |
| Relative Smoke | 0.96 | 1.0 | 0.80 | 0.70 | 1.00 | 0.91 | 0.78 | 1.0 | 0.98 | 1.0 | 0.75 | 0.89 |
| Generated | | | | | | | | | | | | |

| | Formulation 5 | | | | | | | |
|---|---|---|---|---|---|---|---|---|
| Aromatic | Terate | | | Formulation 6 | | Formulation 7 | | |
| Polyester | HT | Sam- | Sam- | Terate | Sam- | Terate | Sam- | Sam- |
| Polyol | 5360 | ple 10 | ple 11 | HT5360 | ple 11 | HT5360 | ple 11 | ple 12 |
| WFE Product? | No | Yes | Yes | No | Yes | No | Yes | Yes |
| Reactivity | | | | | | | | |
| Profiles, secs | | | | | | | | |
| Cream Time | 6 | 6 | 7 | 8 | 9 | nm | | |
| String Time | 13 | 13 | 13 | 14 | 14 | 14 | 14 | 15 |
| Tack Free Time | 21 | 20 | 20 | 20 | 21 | 20 | 20 | 21 |
| Foam Densities | 2.11 | 2.07 | 2.05 | 1.95 | 1.93 | 2.06 | 2.03 | 2.03 |
| Smoke Values | | | | | | | | |
| Test 1 | 2860 | 2313 | 2089 | 2418 | 2081 | 2752 | 2054 | 1675 |
| Test 2 | 2873 | 2201 | 2025 | 2460 | 1878 | 2873 | 1810 | 1922 |
| Test 3 | 3010 | 2216 | 2416 | 2220 | 2155 | 2632 | 1820 | 1755 |
| Average Smoke | 2914 | 2243 | 2177 | 2366 | 2038 | 2752 | 1895 | 1784 |
| Relative Smoke | 1.0 | 0.77 | 0.75 | 1.0 | 0.86 | 1.0 | 0.69 | 0.65 |
| Generated | | | | | | | | |

The comparative smoke data shown in Table 8 demonstrates a consistent reduction in smoke for hand mix spray foams prepared with aromatic polyester polyol containing lower residual glycols. As shown in Table 8, smoke reductions of 20-35% on the foams made with Inventive Polyols versus commercial aromatic polyester polyols and/or versus aromatic polyester polyols with higher residual glycols were observed.

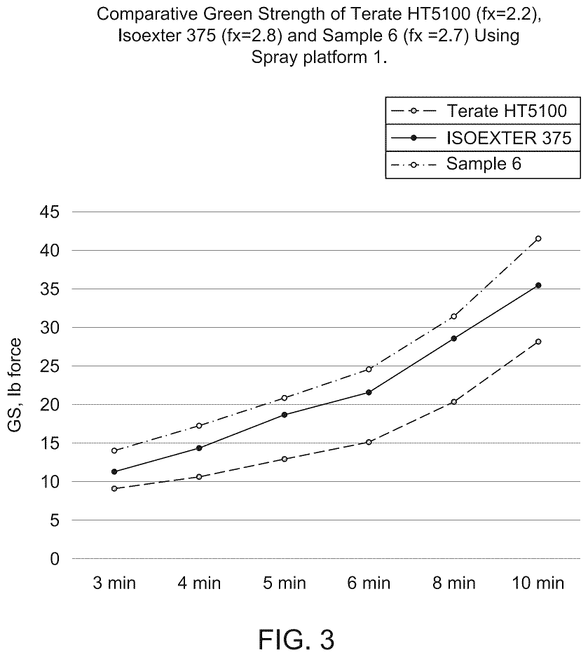

Foams prepared using Formulation 1 (see Table 8) were also tested for green strength. Green strength measures the ability of the foam to withstand force before complete cure take place. Following the foaming method, the top edge of the foam cup was cut to make a smooth flat surface at 2:00 minutes after mixing the A- and B-sides. To measure green strength, a force is applied to the smooth surface sufficient to produce an indentation of 0.35 inches on the foam surface. Green strength of the foam was measured at 3, 4, 5, 6, 8 and 10 minutes after foaming. Test results are shown in FIG. 3. In general, foams with higher overall functionality experience less indentation than foams with less functionality in same densities and reactivities. FIG. 3 shows that the Inventive Polyol with a lower functionality of 2.7 exhibits a higher green strength compared to commercial product with functionality of 2.8.

What is claimed is:

1. An aromatic polyester polyol comprising:
a total product OH value of 150 to 450;
a viscosity of less than 12,000 cps;
an OH value from residual monomer glycols of <30% of the total product OH value
residual monomer glycols in an amount of less than 10 wt %; and
a level of 1,4 dioxanes less than 50 ppm.

2. The aromatic polyester polyol of claim 1, wherein when the total product OH value is less than 220, the residual monomer glycols are less than 4 wt %.

3. The aromatic polyester of claim 1, wherein when the total product OH value is less than 280, the residual monomer glycols are less than 6 wt %.

4. The aromatic polyester of claim 1, wherein when the total product OH value is less than 350, the residual monomer glycols are less than 8 wt %.

5. The aromatic polyester of claim 1, wherein when the total product OH value is less than 450, the residual monomer glycols are less than 10 wt %.

6. The aromatic polyester polyol of claim 1 wherein the aromatic polyester polyol has a functionality of 1.9 to 4.

7. The aromatic polyester polyol of claim 6 wherein the functionality is 1.9 to 2.05.

8. The aromatic polyester polyol of claim 1 wherein the total product OH value is less than 200, and the viscosity is less than 10,000 cps.

9. The aromatic polyester polyol of claim 8 wherein the viscosity is less than 8000 cps.

10. The aromatic polyester polyol of claim 1 without added flame retardants and/or blended additives that reduce polyol hydroxyl value and viscosity.

11. The aromatic polyester polyol of claim 6 wherein the functionality is greater than 2 to 3.5.

12. The aromatic polyester polyol of claim 1 wherein the total product OH value is less than or equal to 220 and the residual monomer glycols are less than 4 wt %.

13. The aromatic polyester polyol of claim 1 wherein less than 30% of the total product OH value is contributed by the residual monomer glycols.

14. The aromatic polyester polyol of claim 13 wherein less than 20% of the total product OH value is contributed by the residual monomer glycols.

15. A process comprising of:
feeding a feed stream comprising a glycol stream and an aromatic stream comprising at least one of aromatic esters and acids, and a catalyst stream to a reactor where:
the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof; and
the aromatic acids/ester is selected from terepthalic acid, isophthalic acids, phthalic acids/anhydrides, trimellitic anhydrides and corresponding esters, or combinations thereof,
reacting the feed stream in the reactor, thereby forming an intermediate product stream comprising aromatic polyester polyols having a total product OH value greater than 250, residual monomer glycols, water, and optionally 1, 4 dioxanes; and
separating the residual monomer glycol in the intermediate stream by a thermal separation process under vacuum into a glycol enriched overhead stream and a product stream having a total product OH value of less than 450, a viscosity of less than 12000 cps; and a level of residual monomer glycols at a level of less than 10 wt %.

16. The process of claim 15 wherein the feed stream further comprises hydroxyl terminated materials.

17. The process of claim 15 wherein the feed stream further comprises at least one of aliphatic acids/esters, fatty acids and natural oils, wherein the aliphatic acids/esters are selected from succinic acids, glutaric acids, adipic acids and/or esters thereof or combinations thereof, the fatty acids are selected from caproic acid, caprylic acid, capric acid, lauric acid, myristic acid, palmitic acid, stearic acid, oleic acid, linoleic acid, ricinoleic acid or mixtures thereof, and the natural oils are selected from soybean oil, sunflower oil, castor oil, corn oil, olive oil, palm oil, tall oil, tallow, or mixtures thereof.

18. The process of claim 15, wherein the reaction is conducted at a reaction temperature of 180° C. to 235° C.

19. The process of claim 15 wherein the vacuum separation is conducted at a temperature of 130° C. to 170° C. and a pressure of 0.1 mmHG to 20 mmHG.

20. The process of claim 16 wherein the hydroxyl terminated materials are alkanolamines selected from diethanolamine, triethanolamine, substituted ethanolamines or mixtures thereof.

21. A polyurethane/polyisocyanurate foam comprising:
a. the aromatic polyester polyol from claim 1;
b. a surfactant;
c. a catalyst;
d. an isocyanate; and
e. a blowing agent.

22. An aliphatic polyester polyol or a mixed aliphatic/aromatic polyester polyol comprising:
a total product OH value of <120;
a viscosity of less than 20,000 cps;
an OH value from residual monomer glycols of <5% of the total product OH value; and
residual monomer glycols in an amount of less than 1 wt %.

23. The aliphatic polyester polyol or the mixed aliphatic/aromatic polyester polyol of claim 22, wherein when the total product OH value is less than 80, the residual monomer glycols are less than 0.5 wt %.

24. The aliphatic polyester polyol or the mixed aliphatic/aromatic polyester polyol of claim 22, wherein the aliphatic polyester polyol or the mixed aliphatic/aromatic polyester polyol has a functionality of 1.9 to 4.

25. A process to produce the aliphatic polyester polyol or the mixed aliphatic/aromatic polyester polyol of claim 22 comprising:
feeding a feed stream comprising a glycol stream and an aromatic stream comprising at least one of aliphatic and/or aromatic esters and acids, and a catalyst stream to a reactor where:
the glycol stream is selected from monoethylene glycol, diethylene glycol, triethylene glycol, tetraethylene glycol, higher glycols, dipropylene glycol, methylpropandiol higher molecular weight polyethylene glycols and polypropylene glycols, higher functionality glycols such as glycerine, trimethylolpropane, pentaerythritol, glucosides and alkylsubstituted glucosides or combinations thereof; and
the aliphatic acids/ester and/or aromatic acids is selected from succinic acid, glutaric acids, adipic acids, terepthalic acid, isophthalic acids, phthalic acids/anhydrides, trimellitic anhydrides and other diacids/polyacid and corresponding esters, or combinations thereof,
reacting the feed streams in the reactor, thereby forming an intermediate stream with residual monomer glycols more than 0.8%,
separating the excess residual monomer glycol intermediate product stream by a thermal separation process under vacuum into a glycol enriched stream in the overheads and the aliphatic polyester polyol or the mixed aliphatic/aromatic polyester polyol.

26. A polyurethane foam comprising:
a. the aliphatic polyester polyol or the mixed aromatic polyester polyol of claim 22;
b. a surfactant;
c. a catalyst;
d. an isocyanate; and
e. a blowing agent.

27. The process of claim 25 wherein the total product OH value of the intermediate product stream is greater than 15% of the total product OH value of the aliphatic polyester polyol or the mixed aliphatic/aromatic polyester polyol.

28. The aliphatic polyester polyol or the mixed aliphatic/aromatic polyester polyol of claim 23, wherein the residual monomer glycols are less than 0.1 wt %, and the viscosity is <18000 cps.
